(19) United States
(12) Patent Application Publication
(10) Pub. No.: US 2010/0250015 A1
(43) Pub. Date: Sep. 30, 2010

(54) System and Methods for Distributed Web-Enabled Monitoring, Analysis, Human Understanding, and Multi-Modal Control of Utility Consumption

(75) Inventor: Paul Glen Flikkema, Flagstaff, AZ (US)

Correspondence Address: Visible Energy, Inc., 303 W. Fir Avenue, Flagstaff, AZ, 86001, US

(73) Assignee: VISIBLE ENERGY, INC., Flagstaff, AZ (US)

(21) Appl. No.: 12/507,033

(22) Filed: Jul. 21, 2009

Related U.S. Application Data
(60) Provisional application No. 61/082,833, filed on Jul. 23, 2008.

(51) Int. Cl. G06F 1/28

(52) U.S. Cl. 700/295

(57) ABSTRACT

A system and methods that allow a utility or energy consumer to measure, visualize, understand, and control use of energy and other utilities is disclosed. These actions may be performed via a distributed web-enabled system. It derives and presents useful information for consumers by first providing a means for the assimilation (including real-time), maintenance, and modification of aggregated use data. The information is derived from the data by web-based software tools that provide comparison with models and the ability for consumers to share and compare their consumption. It can also include the ability to discuss and share (via text, voice, or computer algorithms) ideas and control strategies for saving energy and lowering energy use. Consumers may implement these control strategies in algorithms for manual; automatic scheduled; automatic scheduled with manual override; and dynamic rate-based control of energy/utility usage.

### BACKGROUND OF THE INVENTION

1. Field of the Invention

The present invention relates to solutions to the problem of measuring, evaluating, interpreting, understanding and controlling use of energy and/or other utilities. In particular, the present invention relates to distributed and integrated system of wireless and wired networking infrastructure and distributed computing devices implementing algorithms and software for this purpose.

2. Related Art

With energy prices rising, there is an increasing need for meaningful, quantitative understanding of energy consumption and consumption all utilities, as well as informed planning of consumption. Solutions to date have focused on measurement, known as monitoring, of energy use. Many devices exist for on-site monitoring of electric energy consumption. Furthermore, solutions for remote monitoring of energy consumption by utilities or third parties are in production, some under the rubrics of smart metering and Automated Meter Infrastructure (AMI).

Market demand for these systems has been limited because the perceived value is less than their cost, which includes both the initial financial cost and the time required to effectively use them. While initial cost is expected to fall due to improvements in electronics technologies in conjunction with adoption of various protocols and standards for data communication, the value of the reported data may still not justify the required time investment of the consumer. The underlying cause of this cost is the difficulty of understanding and interpreting utility usage information, preventing the consumer from learning about his/her energy consumption, interpreting it relative to both models and the consumption patterns of other consumers, and evaluating appropriate actions to change consumption. Finally, current systems do not give the consumer the control needed to implement chosen actions. There is an according need for an integrated energy/utility monitoring, interpretation, understanding, and management solution to address these limitations.

### BRIEF SUMMARY OF THE INVENTION

The present invention provides a distributed, integrated system and methods for web-enabled monitoring, analysis, human understanding, and control of consumption of energy and other utilities. It derives and presents useful and actionable information for energy and utility consumers by providing a means for automated and real-time data assimilation of energy/utility consumption data; analysis of the data using models and comparison with shared data from other consumers; human viewing, discussion, interpretation and understanding of the data and strategies, algorithms and software for management of consumption; and multi-modal control of consumption.

### BRIEF DESCRIPTION OF THE DRAWINGS

FIG. 1 is a component-level model of the present invention.

FIG. 2 is data/control flow diagram of the present invention.

### DETAILED DESCRIPTION OF THE INVENTION

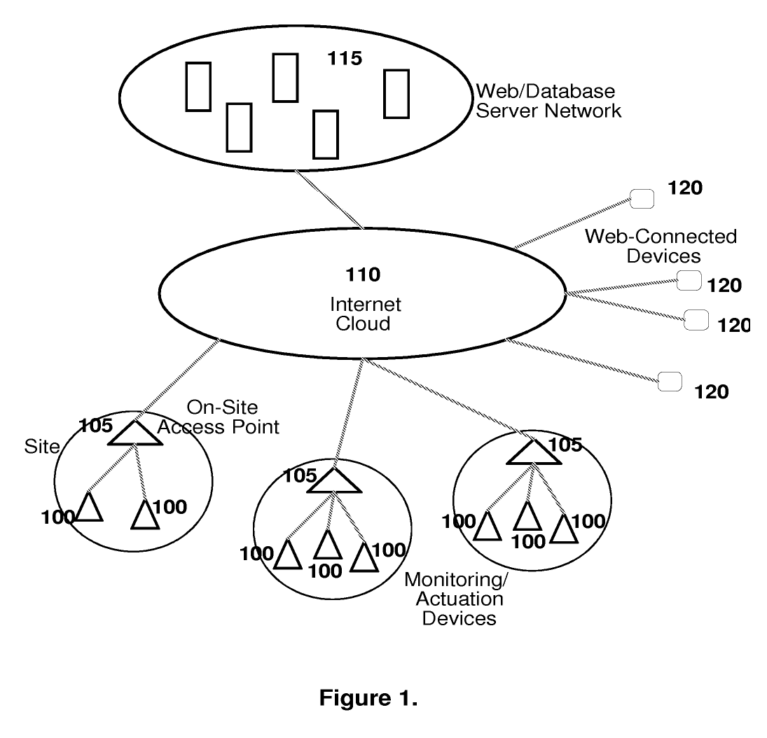

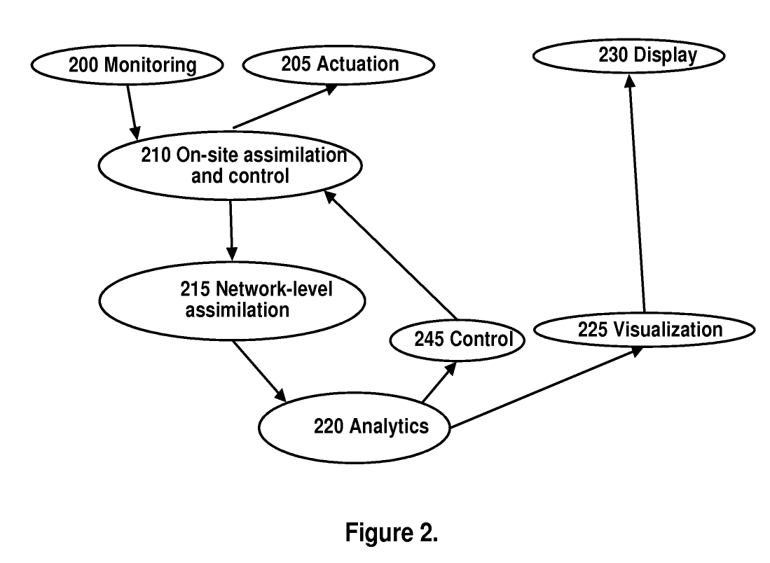

As shown in FIG. 1, one component of the system consists of monitoring and actuation infrastructure located at a site, i.e., at a single-family dwelling, townhouse, apartment, condominium, or place of business. This infrastructure consists of a plurality of networked monitoring/actuation devices 100 for monitoring 200 and actuation 205 of utility or energy consumption (see FIG. 2) of energy and utility consumption, with devices for individual measurement points (such as an electrical outlet), subsystems (e.g., at the circuit-breaker level) and for the entire site. The sensing of power can be performed by any of several technologies, including split-core current transducers, Rogowski coils, Hall-effect sensors, and precision in-line resistors, with possible mediation by dedicated energy-measurement chips (available from manufacturers such as Analog Devices and Texas Instruments) that may detect current and voltage amplitude and phase information for estimation of real and apparent power.

These devices are organized into a network by an on-site access point 105. The network is a logical star network (which in different embodiments may be implemented as a physical star or mesh network) that can use any of a number of standardized or proprietary networking technologies exclusively or in combination, including wire-line (e.g., Ethernet or RS-485) power-line (e.g., X-10), and wireless (e.g., 802.15.4, Zigbee, Zigbee Pro, Z-Wave, or 802.11x/WiFi). Monitoring of the entire site may be by means of agreement with a utility provider to provide the data from the provider's smart meter or AMI systems. The conversion of sensed voltage, current or power to energy may be performed using resident software in the monitoring/access devices 100 or the on-site access point 105.

The on-site access point 105 also serves as a bridge between the on-site infrastructure and a distributed web/database server network 115 via the internet and world-wide web 110. The interface between the on-site access point 105 and an internet portal device (e.g., a cable or DSL modem) can be via a number of means, including USB, Ethernet, or wireless (802.11x/WiFi, Bluetooth, or WiMAX). The on-site access point performs on-site data assimilation 210 from the monitoring/actuation devices. The on-site access point 105 also functions as a server and controller for the entire site, relieving individual monitoring/actuation devices 100 from the cost burden of independent internet connectivity.

The web/database server network 115 has several functions, implemented by resident software programs and databases. First, it performs network-level data assimilation 215 from the plurality of on-site access points 105 installed at consumer sites. This assimilation may be performed using any of several methods, including the primary method of on-site monitoring and actuation devices 100, as well as manual input using web-connected devices 120 by the customer, human-directed uploading of files in various standard formats (e.g., .csv, .xls, and .xml), and automatic interrogation (e.g., via a web services API) of the customer's utility web site by any of several electronic or other means pre-arranged with the utility. Assimilated information includes real-time and summary (such as monthly) consumption data as well as scheduled and dynamic real-time financial cost (utility rate) data.

The second function of the web/database server network is the analysis 220 of the assimilated data that is used to provide useful information to customers based on optimization of human understanding. This includes aggregation of information from multiple sites (when a customer has defined multiple sites in the customer's account). The analytic tools include the ability to find and/or derive intra-site temporal comparison data and inter-site comparison data and information based on data and derived models from the plurality of sites, including temporal data. The output of the analysis also includes predictive data products that inform the customer of the results of potential energy/utility consumption decisions. The data products are based on models and measurements, and result from basic comparisons as well as statistical analyses that incorporate covariate information about the site and its use patterns. Covariate information includes lighting and heating/ventilation and cooling (HVAC) energy sources and technologies used, site size (area or volume), number of people resident, and changes in customer behaviors, technologies or usage patterns.

The analysis 220 of the assimilated data includes capabilities that aid human understanding and interpretation of utility usage information. This includes algorithms and tools for humans to share utility use data and compare their data using web-based social networking tools. It can also include the ability to discuss and share (via text, voice, or computer algorithms) ideas, control strategies, and algorithms for saving energy and lowering their energy use and costs.

Another function of the web/database server network 115 is the rendering 225 of interactive visual displays 230 for customers that include panels for raw and post-analysis data products and site control. The fully web-enabled displays are viewable anytime and anywhere via customers' interne-connected and web-enabled devices 120, including laptop and desktop computers, mobile phones, mobile interne devices, and ambient information devices. The rendering and display capabilities also provide the means for humans to share, compare, and discuss data, ideas, strategies, and algorithms as described in the previous paragraph.

The web/database server network 115 hosts software-implemented methods for multi-modal control 245 of energy and utility consumption via the on-site access point 105 and the monitoring/actuation devices 100. These methods include the following modes: (i) manual customer control based on displays 230 of monitoring data; (ii) automated control based on pre-programmed schedules that can be created, modified; and overidden by the customer; and (iii) dynamic rate-based control driven by real-time monitoring of consumption and utility rates, as well as customer requirements and preferences.

The web/database server network 115 provides redundancy, security and privacy capabilities as part of its task of supporting anytime/anywhere data/information access and control. Security provisions cover both access by the customer and machine-to-machine communication between the data server network and the on-site access point servers. To secure consumers' on-site infrastructure from spoofing, the web/database server network 115 and the on-site access point 105 implement a security protocol to authenticate each other and individual on-site monitoring and actuation devices 100. In case of network failures, the system may automatically revert to local access and control functionality resident on the on-site access point 105.

The consumer's use of the present invention requires time-tagging of energy/utility use information; for example, if an appliance (such as refrigerator) turns on at a particular time, e.g., 8:07 AM in the user's local time, this time should be reflected in the data analysis and the resulting interactive graphical products 230 on the consumer's web-enabled device. If the consumer wishes to program actuation of an appliance for a certain interval (e.g., to take advantage of a temporary rate reduction) using automated control, the resulting actuation commands must be triggered within approximately 1 second of the desired time. The present invention incorporates an automated time acquisition and distribution system allowing time-tagging of use data and accurate triggering of actuation commands at the monitoring/actuation devices 100.

In one example embodiment of the current invention, the consumer or a technician installs individual monitoring/actuation devices 100 and the on-site access point 105; these self-organize into a network using any of several wireless means as described earlier. The on-site access point 105 is connected to the internet using the consumer's preferred means; this will typically be via an Ethernet cable from the on-site access point 105 to a cable, DSL, cellular, or satellite modem. The on-site access point 105 will automatically establish a secure internet connection 110 to the web/database server network 115 via the consumer's cable, DSL, cellular, or satellite service using standard UDP, Datagram Congestion Control Protocol (DCCP), or TCP/IP lower-level protocols. The on-site access point 105 also contacts an internet time server to acquire accurate time using a standard protocol such as Simple Network Time Protocol (SNTP), converts Coordinated Universal Time (CUT) to local time, and then propagates this time to the monitoring/actuation devices 100. At this point the monitoring/actuation devices will initiate monitoring (including time-tagging) 200 of energy/utility use information which will flow via on-site wireless data assimilation 210 from the individual monitoring/actuation devices 100 through the on-site access point 105 and via network-level assimilation 215 over the internet 110 (using secured UDP or DCCP) into the web/database server network 115.

An example embodiment of the monitoring/actuation devices 100 and the on-site access points 105 is based on low-cost software-programmable microcontrollers interfaced with (i) a collection of current, voltage, or power transducers, (ii) actuation devices including mechanical and solid-state relays, and (iii) a low-cost single-chip wireless transceiver. Monitoring/actuation capability can be integrated into the on-site access point 105 to lower costs in some installations. Progress in microelectronic process technology will enable the eventual integration of these capabilities on a single monolithic chip. The complete functionality of 100 and 105 is implemented using embedded software. These devices can be powered by batteries, line power with appropriate regulation, or scavenging the sensed power.

Software resident on the web/database server network 115 provides a collection of services to the user that aid human understanding and interpretation of utility usage information via any web-connected device 120, including PC's, laptops, mobile phones, and dedicated devices. This collection of services, or analytics, 220 includes (i) visualization 225 of energy/utility use via summary charts and graphs as well as real-time reporting using interactive numerical and graphical strip-chart displays 230; (ii) model-informed, predictive data products that inform the consumer of the results of potential energy/utility consumption decisions; (iii) web-enabled, networked algorithms and tools for users to share utility use data and compare their data; and (iv) web-enabled, social networking tools for consumers to discuss and share (via text, voice, and computer algorithms) ideas and control strategies for saving energy and lowering their energy use and cost. Based on user-developed and directed control strategies, the web/database server network 115 also sends time-tagged control information 245 to the monitoring/actuation devices 100 via the on-site access point for management via actuation 205 of energy/utility usage.

1. A system consisting of a collection of devices and methods for distributed web-enabled monitoring, analysis, visualization, human understanding, and multi-modal control of utility and/or energy consumption via the internet and world-wide web.

2. A component of the system of claim 1 consisting of a plurality of on-site (e.g., located at a home or place of business) networked monitoring/actuation devices for monitoring and actuation of energy and utility consumption (including, but not limited to electricity, natural gas, oil, and water/sewer services), providing control of energy/utility use for the entire site, subsystems, and end points.

3. A component of the system of claim 1 consisting of a web/database server network.

4. A component of the system of claim 1 consisting of an on-site access point linked to the on-site measurement and actuation devices of claim 2 and the web/data server network of claim 3.

5. A component of the system of claim 1 consisting of a plurality of internet-connected web-enabled human interface devices, including, but not limited to, personal desktop and laptop computers, mobile phones, mobile internet devices and ambient information devices.

6. A component of the system of claim 1 consisting of analytical methods and visualization tools to enable understanding by human users of the system of site energy and other utility consumption via comparison of consumption based on data and derived models with other sites and other users of the system, and prediction of future energy consumption and cost of potential decisions.

7. A component of the system of claim 1 consisting of networked, web-delivered methods, algorithms, and computer/human interfaces to aid human understanding, including the ability for humans to share, compare, and discuss (via voice, text, or computer software) utility use data, ideas, and control strategies for saving energy and lowering their energy use and cost.

8. A component of the system of claim 1 consisting of methods for coordinated multi-modal control of entire-site, subsystem, and end-point energy and utility consumption.

9. A subcomponent of the component of claim 7 consisting of methods for human control.

10. A subcomponent of the component of claim 7 consisting of methods for automated, scheduled control with optional human override.

11. A subcomponent of the component of claim 7 consisting of methods for adaptive control based on real-time monitoring of consumption, real-time financial cost, and customer requirements and preferences.
